(19) United States
(12) Patent Application Publication
(10) Pub. No.: US 2006/0152804 A1
(43) Pub. Date: Jul. 13, 2006

(54) Electromagnetic radiation viewing device with polarization indicator and method of making same

(76) Inventor: Thomas Bove, Spokane, WA (US)

Correspondence Address: CISLO & THOMAS, LLP, 233 WILSHIRE BLVD, SUITE 900, SANTA MONICA, CA, 90401-1211, US

(21) Appl. No.: 11/034,393

(22) Filed: Jan. 11, 2005

(51) Int. Cl. G02B 5/30; G02B 27/28

(52) U.S. Cl. 359/487

(57) ABSTRACT

Exemplary embodiments disclosed herein are directed to a device for viewing magnetic lines of flux and polarization, including microencapsulated ferro-magnetic particles configured to indicate magnetic lines of flux; and an indicator configured to indicate the polarity of a magnetic device or field.

### BACKGROUND

Many magnetic devices may be utilized in people's everyday lives for therapy, manufacturing, crafts, and the like. There may be available various magnetic viewing devices that may reveal electromagnetic configurations when positioned near an electromagnetic source. These devices may be limited in that, although they may indicate an electromagnetic field is present, they may not indicate the configuration or polarity of the electromagnetic source.

### SUMMARY

Exemplary embodiments disclosed herein are directed to an electromagnetic radiation viewing device with polarization indicator, and a method for using the same.

### BRIEF DESCRIPTION OF THE DRAWINGS

FIG. 1 is a perspective view of an electromagnetic radiation-viewing device according to an exemplary embodiment.

FIG. 2 is a cutaway view of an exemplary embodiment.

FIG. 3 is a perspective view of an electromagnetic radiation-viewing device according to an exemplary embodiment.

### DETAILED DESCRIPTION

The detailed description set forth below in connection with the appended drawings is intended as a description of exemplary embodiments and is not intended to represent the only forms in which the embodiments may be constructed and/or utilized. The description also sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

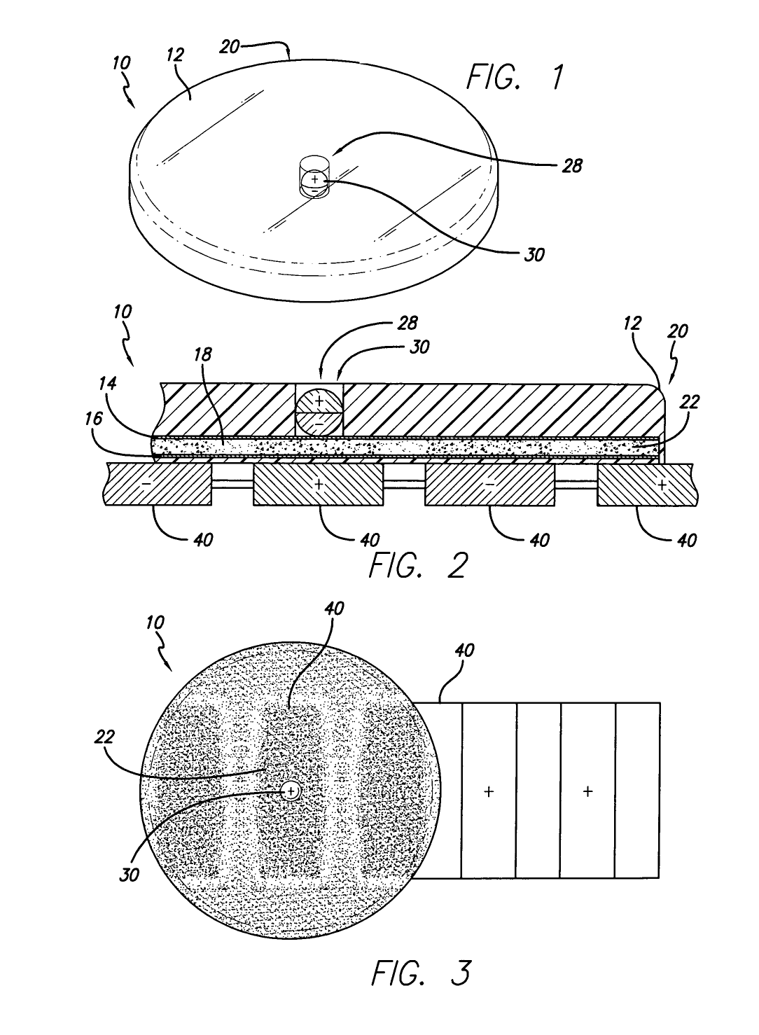

A system according to an exemplary embodiment is shown in FIG. 1, generally at 10. System 10 may include a housing 12, which may include a chamber 28. Within chamber 28 may be an indicator 30 such that the indicator may be configured to indicate the polarity of a magnetic device or material, as desired. Indicator 30 may be a magnetic material such that one portion may be positively charged and another portion may be negatively charged such that when magnetic opposites attract, the polarity of the magnetic material that the system is placed adjacent to may be indicated by indicator 30.

FIG. 2 shows a cross-section of a system according to an embodiment of the present invention generally at 10. Also, included in FIG. 2 is a magnetic material 40 that is charged or has magnetic properties as shown with the positive and negative indicators. When system 10 is placed near or adjacent to magnetic material 40, indicator 30 will rotate within chamber 28, such that the polarity of magnetic material 40 will be known.

System 10 may further include film 14 and film 16, which may enclose encapsulated magnetic material 22 within a fluid 18. Encapsulated magnetic material 22 may be a microencapsulated ferrous-type material, or other magnetic material, such that it will indicate the magnetic flux lines of magnetic material 40 when system 10 is placed near that magnetic material. With this configuration, the magnetic flux lines, as well as the polarization of magnetic material 40 may be determined by placing system 10 adjacent or near magnetic material.

Film 14 may be translucent and be made from a polymer, plastic, or other material, such that encapsulated magnetic material 22 may be viewed. Film 16 may be opaque, and have a dark or lightly colored upper surface that may allow the orientation of encapsulated magnetic material 22 to be viewed, as desired. Fluid 18 may be a silicon based fluid, or other fluid, such that when encapsulated magnetic material 22 is affected by the magnetic flux lines of magnetic material 40, the encapsulated magnetic material 22 may align or orient with the flux lines of magnetic material 40, and there may be spaces in which the fluid 18 or film 16 may be seen such that the magnetic flux lines of magnetic material 40 will be discernable.

FIG. 3 shows a top view of an embodiment generally at 10, when system 10 is placed adjacent magnetic material 40. Encapsulated magnetic material 22 will align with magnetic flux lines such that the magnetic material may be identified with respect to non-magnetic material. Furthermore, indicator 30 may align such that the polarization of magnetic material may be easily discernable, also. With this configuration, magnetic material may be discerned from non-magnetic material, the flux lines of the magnetic material may be discernable, and the particular polarization of the magnetic material may be easily discernable.

This system may be useful for many applications including, but not limited to, magnetic jewelry, magnetic therapeutic devices, and many other applications where magnetic material, magnetic flux lines, and polarization of a magnetic material may be needed to be discerned from other material.

Film 14 and 16, as well as fluid 18 and encapsulated magnetic material 22 may make up an encapsulated ferro-magnetic particle film, herein after called EMPS. If a magnetic field is applied to the EMPS in a direction, which is perpendicular to the surface, the encapsulated magnetic material 22 will align in a direction that is perpendicular to the surface. Because the magnetic material that is encapsulated is very thin, the majority of the light arriving at or incident to the system will pass directly between the encapsulated magnetic material 22 and be absorbed by the opaque film 16. This absorption of light by opaque film 16 and the reflection of light from the encapsulated magnetic material 22, which have not been affected by the magnetic field, will provide the necessary contrasts to enable a user to see the magnetic material and the magnetic lines of flux caused by the material.

In an actual situation, not all of the encapsulated magnetic material 22 may align perfectly, as shown in FIG. 3, but a significant number may be so aligned so as to provide the necessary contrast for the viewing of the magnetic material and magnetic lines of flux. After viewing the magnetic material and the flux lines, the system 10 may be removed from close proximity to the magnetic material 40. After removal of the system 10, the image formed thereon will be retained. This is due to the fact that the EMPS used exhibits memory characteristics and requires some form of erasure prior to being reused. The image formed in the system may be erased by subjecting it to a magnetic field to realign the encapsulated magnetic material 22.

The active material in the encapsulated magnetic material 22 preferably contains microscopic nickel platelets or flakes, however, other encapsulated magnetic particles, for example, in the shape of needles rather than flakes and/or composed of other materials such as ferric oxide may be utilized, as desired.

Although the device is shown as circular, or cylindrical, many different shapes and configurations may be utilized, as desired. Although one indicator 30 has been shown, any number of indicators may be utilized such that a larger device may view different magnetic materials at the same time. Furthermore, although indicator 30 is shown as being generally spherical, other shapes and configurations may be utilized, as desired.

Housing 12 may be made of a polymer, polycarbonate or plastics, or combinations thereof, or other materials such that it is translucent on the top and somewhat opaque at the bottom to allow the magnetic material, magnetic lines of flux, and polarization of the magnetic material to be viewed as described above. Furthermore, although housing is shown as a generally cylindrical shape, other configurations may be utilized, as desired.

System 10 may also include a handle or other accessories, as desired. Furthermore, system 10 may include a cover such that the device may not be damaged in transport or when not being used. The system 10 may be 1-2 inches in diameter and may be 0.1-0.5 inches thick, however, other dimensions and configurations may be utilized, as desired.

Housing 12 may also include viewing film 20, which may enable a user to discern magnetic material from non-magnetic material, as well as discern the magnetic flux lines of a magnetic material that is placed adjacent to system 10, or in a position such that the magnetic material and magnetic lines of flux may be discerned.

Viewing film 20 may include a film 14, which may be translucent, a film 16 that may be opaque, and encapsulated magnetic material 22 suspended in a fluid 18, which may be between film 14 and film 16 such that when a magnetic material 40 is placed near or in proximity to system 10 and viewing film 20, the magnetic material may be discerned from the non-magnetic material. Furthermore, the magnetic lines of flux of the magnetic material may be discerned, and utilizing indicator 30, the polarization of the magnetic material may be discerned also.

Fluid 18 may be a silicon oil or fluid, or other fluid that may suspend encapsulated magnetic material 22. Fluid 18 may be approximately 100 csf, however other configurations and materials may be utilized, as desired.

In closing, it is to be understood that the exemplary embodiments described herein are illustrative of the principles of the present invention. Other modifications that may be employed are within the scope of the invention. Thus, by way of example, but not of limitation, alternative configurations may be utilized in accordance with the teachings herein. Accordingly, the drawings and description are illustrative and not meant to be a limitation thereof.

What is claimed is:

1. A device for viewing magnetic lines of flux and polarization, comprising:
viewing film configured to indicate magnetic lines of flux; and
an indicator configured to indicate the polarity of a magnetic device or field.

2. The device of claim 1, further comprising microencapsulated ferro-magnetic particles configured to indicate magnetic lines of flux.

3. The device of claim 1, further comprising fluid in which said microencapsulated ferro-magnetic particles are suspended.

4. The device of claim 3, wherein said fluid is silicon based.

5. The device of claim 1, further comprising one or more film elements adjacent said fluid.

6. The device of claim 4, wherein at least one of said one or more film elements is translucent.

7. The device of claim 4, wherein at least one of said one or more film elements is opaque.

8. The device of claim 1, further comprising a housing configured to enclose the system.

9. The device of claim 7, wherein said housing is a polymer.

10. A system for viewing magnetic elements or magnetic lines of flux, comprising:
microencapsulated ferro-magnetic particles configured to indicate magnetic lines of flux;
fluid adjacent to said microencapsulated ferro-magnetic particles;
one or more film elements adjacent to said fluid;
an indicator configured to indicate the polarity of a magnetic device or field, and
a housing configured to enclose said system.

11. The device of claim 9, wherein said fluid is silicon based.

12. The device of claim 9, wherein said housing is a polymer.

13. The device of claim 9, wherein at least one of said one or more film elements is translucent.

14. The device of claim 9, wherein at least one of said one or more film elements is opaque.

15. A method of viewing magnetic elements or magnetic lines of flux, and determining polarization, comprising:
positioning a magnetic viewing device with polarization indicator adjacent an electromagnetic radiation source;
determining the orientation of the magnetic flux lines from said electromagnetic radiation source utilizing said viewing device; and
determining the polarization of the electromagnetic radiation source utilizing said indicator.

16. The method of claim 12, wherein said determining the orientation of the magnetic flux lines is accomplished, at least in part utilizing microencapsulated ferro-magnetic particles suspended in a fluid.

17. A method of making a electromagnetic radiation viewing device with polarization indicator, comprising:
providing magnetic viewing film;
positioning a polarization indicator adjacent said magnetic viewing film; and
coupling said magnetic viewing film and said polarization indicator via a housing.

18. A method of making a electromagnetic radiation viewing device with polarization indicator, comprising:
providing microencapsulated ferro-magnetic material;
suspending said microencapsulated ferro-magnetic material in a fluid;
enclosing said microencapsulated ferro-magnetic material in a fluid via thin film;
positioning a polarization indicator adjacent said film; and
coupling said film and said polarization indicator via a housing.
